(19) United States
(12) Patent Application Publication
(10) Pub. No.: US 2012/0322509 A1
(43) Pub. Date: Dec. 20, 2012

(54) METHOD FOR GENERATING A VIDEO RING TONE

(76) Inventor: Mikael Jansson, Uppsala (SE)

(21) Appl. No.: 13/524,388

(22) Filed: Jun. 15, 2012

Related U.S. Application Data
(60) Provisional application No. 61/497,628, filed on Jun. 16, 2011.

(51) Int. Cl. H04W 88/02

(52) U.S. Cl. 455/567

(57) ABSTRACT

A method for generating a video-ring tone for a mobile communication device, comprising the steps of: receiving and processing an incoming call, step (100a); looking up caller information for providing video ring tone information associated with a caller, step (100b); inputting the video ring tone information associated with a caller into a ring tone module, step (100c); and outputting a particular video ring tone in dependence of a particular caller, instead of an audio ring tone, step (100d).

### CROSS-REFERENCE TO RELATED APPLICATION

This application claims the benefit of U.S. Provisional patent application No. 61/497,628 filed on Jun. 16, 2011, the contents of which are incorporated herein by reference.

### FIELD OF THE INVENTION

The present invention relates to ringtones. More specifically, the present invention relates to a method for generating a video-ring tone in a mobile communication device and a method for providing the mobile communication device to be able to generate a video ring tone by means of the inventive method. The present invention is also related to a computer program product for implementing the method(s), as well as a device provided therefore.

### BACKGROUND OF THE INVENTION

Today, a user of a mobile communication device such as a mobile telephone or smart phone can select a personalized ringtone to be played on his/her mobile communication device when a particular caller calls the user instead of a default ring tone provided by the mobile communication device manufacturer. There are also a number of service providers that produces and distributes means for allowing a user to generate and/or create personalized ring tones on his/her mobile communication device.

Recently, multimedia has found a use on mobile communication devices such that a multimedia clip can be associated with a contact, typically a caller, and played when a call is received from the contact. Typically, a contact can only be associated with a multimedia clip that is downloaded to the phone. It is known to play a video clip at the same time the ring tone is created when a caller calls the device. Normally, the personalized ring tone is stored locally only on the device. This is a drawback, for instance if the user loses or switches his/her mobile communication device. In that case, the user typically, has to purchase and download the ring tone or the video clip once again.

It can also be a drawback if the ring tone is only provided centrally.

### SUMMARY OF THE INVENTION

An object of the present invention is to provide a method for automatically providing a video ring tone in a mobile communication device instead of an audio ring tone, wherein the video ring tone is stored locally on the mobile communication device, but is also stored centrally such that it can be down-loaded again in case it is required.

According to an embodiment of the present invention, there is provided a method for generating a video ring tone for a mobile communication device. The method comprises the steps of:

receiving and processing an incoming call;

looking up caller information for providing video ring tone information associated with a caller; inputting the video ring tone information associated with a caller into a ringtone module; and

outputting a particular video ringtone in dependence of a particular caller instead of an audio ring tone.

Herein , the term “ring tone information” includes conventional ring tone information, but also SMS, MMS and alarm notifications. Thus, by means of the invention, a video clip is outputted instead of a conventional ring tone, but also SMS, MMS and alarm notifications.

In some embodiments the signal associated with a caller is also associated with similarity data. The similarity data identifies other video ring tones, typically sequences that are similar to the video ring tone associated with the caller. In these embodiments the method comprises selecting one of the similar video sequences from the video sequences or identified by the similarity data.

The method is typically implemented by means a computer program product, such as a computer application product, often referred to as an “app” comprising in a computer executable code means, when loaded into the computer to perform the method. The mobile communication devices of today typically comprise memory/memories and processor(s) suitable for implementing the features of the inventive method.

A device for generating video ringtones is also described for example a mobile phone or smart phone. The device comprises a communications interface configured to receive an incoming call from a caller and video media over a mobile telephone network, an analyzer for looking up caller information for providing video ring tone information associated with a particular caller and a ring tone module arranged to output a particular video ring tone in dependence of a particular caller, instead of an audio ring tone, wherein communications interface, the analyzer and ring tone module are arranged to communicate with each other.

There is also described a method for providing video-ringtone generation in a mobile communication device. The method comprises the steps of:

providing video content items;

inputting into a mobile communication device a particular video content item;

associating the particular video content item with a particular caller; and

providing a data base with video ring tone information associated with a particular caller.

This method is used initially for personalization purposes, which will be described later on.

The invention can be achieved in all types of mobile communication devices such as smart phones, PDAs or the like.

### BRIEF DESCRIPTION OF THE DRAWINGS

The features and advantages of the present invention will become further apparent from the following detailed description and the accompanying drawing, of which:

FIG. 1 shows a flow chart of a method according to an embodiment of the present invention;

FIG. 2 shows a block schematic of a device for generating video ring tones according to an embodiment of the present invention;

FIG. 3A shows a block schematic for illustrating a method according to an embodiment of the present invention;

FIG. 3B shows a block schematic for illustrating how personalization is performed; and

FIG. 4 shows a block schematic for illustrating a method according to an alternative embodiment of the present invention in relation to the embodiment shown and described in relation to FIG. 3A.

### DETAILED DESCRIPTION

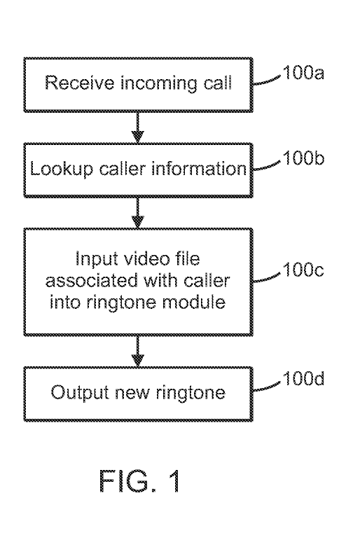

Referring now to FIG. 1, which shows a flow chart of a method for generating a video ring tone in a mobile communication device (not shown) communicating with a mobile communication network (not shown) according to an embodiment of the present invention, the principle of the present invention will be described as follows. FIG. 1 shows how an incoming call is processed.

In a first step, an incoming call, is received and processed, step 100a. When an incoming call is received, the network (not shown) can provide information about the caller (sometimes also referred to as a calling party). In some cases the network can provide only the telephone number or network address of the caller, but in other cases the network can also provide the name of the caller (none of these cases are shown in detail because they are well known). Then, in a second step, caller information for providing video ring tone information associated with a caller is looked up, step 100b. By means of this information, the mobile communication device can look up additional information about the caller in the mobile communication device's memory. Then, in a third step, step 100c, the video ring tone information associated with a caller such as the parameters that control the actions to be taken based on the analysis of the signal is input into a ring tone module. Then in a fourth step, a particular video ring tone in dependence of a particular caller instead of an audio ring tone is put out, step 100d. Typically, once the mobile communication device determines which media should be played in response to the incoming call, it can retrieve the associated files and input the files into the ring tone module for processing and a video ring tone is output to notify the user of the mobile communication device of the incoming call.

Even if this embodiment only describes a video ringtone instead of a conventional audio ring tone, the invention is by no means limited to this. The invention can also be used for outputting a video clip instead of a SMS, MMS or alarm notification. In the case of SMS or MMS, of course the ID of the sender can be identified conventionally by the mobile communication device.

The invention is based on a built-in store and features for selecting video instead of audio as regards conventional ring tone, personalized ring tone, SMS, MMS or alarm notification. The data base is also stored centrally, typically on the web such that a user having lost or switched his/her mobile communication device ca re-load and use the application product once more, log-in to his/her account and re-use all already purchased video clips by downloading and using the same as before without having to purchase them once again.

Even if the same signal is used every time a call is received from the same caller, different video ring tones can still be achieved by varying the parameters that control the analysis of the signal and the parameters that control the actions to be taken based on the analysis of the signal. This is no explicitly shown.

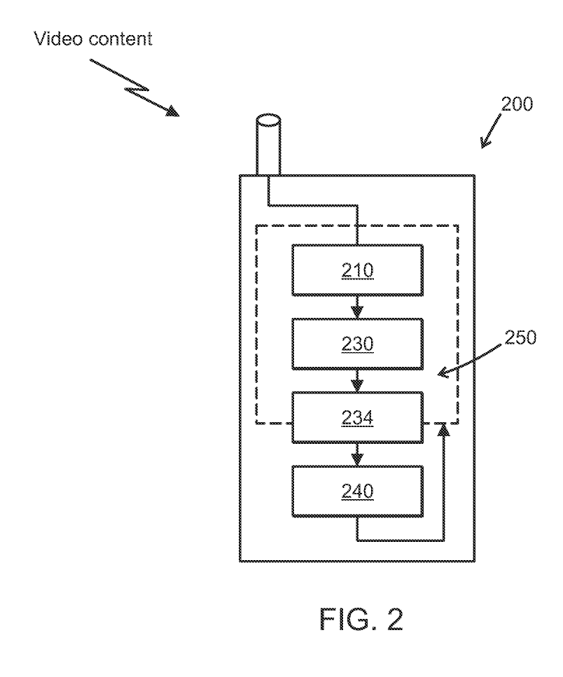

FIG. 2 shows a mobile communication device 200 for generating video ringtones, herein a smart phone. The device 200 comprises a communications interface 210 configured to receive an incoming call from a caller and video media over a mobile telephone network 220. The device 200 further comprises an analyzer 230 for looking up caller information for providing video ring tone information associated with a particular caller connected to the interface 210. The analyzer 230 is configured to process information about the caller and to look up information in a memory 232 having video ring tone information storage 234 of contact associations such as the name of a particular caller and which video content is associated with a particular caller. The content associated with the caller stored in the video ring tone information storage 234 can be contained within a conventional memory of the device 200 by means of suitable software therefore. The analyzer 230 can analyze the caller's signal for any characteristics of interest providing information about which video media is associated with a particular caller. The video ring tone information associated with the caller is input into a ring tone module 240. The ring tone module 240 receives the original signal from the caller and based on the analysis of the signal from the analyzer 230, the ring tone module 240 outputs the video ring tone to a display 250 instead of an audio ring tone.

The video content can be downloaded into the mobile communication device or recorded directly onto the device. For example, video content such as video files can be available for download from an online store, but can also be downloaded directly from some other source on the internet straight to the device. In some embodiments, the video content, such as files, are downloaded from or by means of a personal computer. For example, video files purchased from an online store can be stored on a personal computer and can be uploaded or downloaded onto the device via a direct connection such as when connecting a smart phone to a personal computer providing the media content. In some embodiments the video content can be recorded directly onto the device using the device's video recording features. This will be described as follows.

While FIG. 2 illustrates the video ring signal and contact associations as part of the same memory 234, it should be appreciated that they may be part of one or more memories. Likewise, the inventive method can be performed with software or hardware and if software, it can be executed on one more processors including processors with specialized functions.

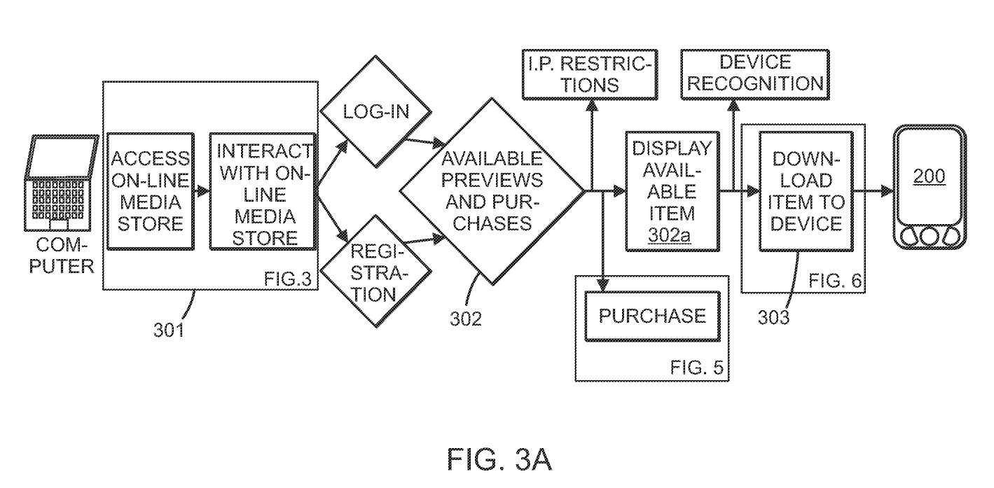

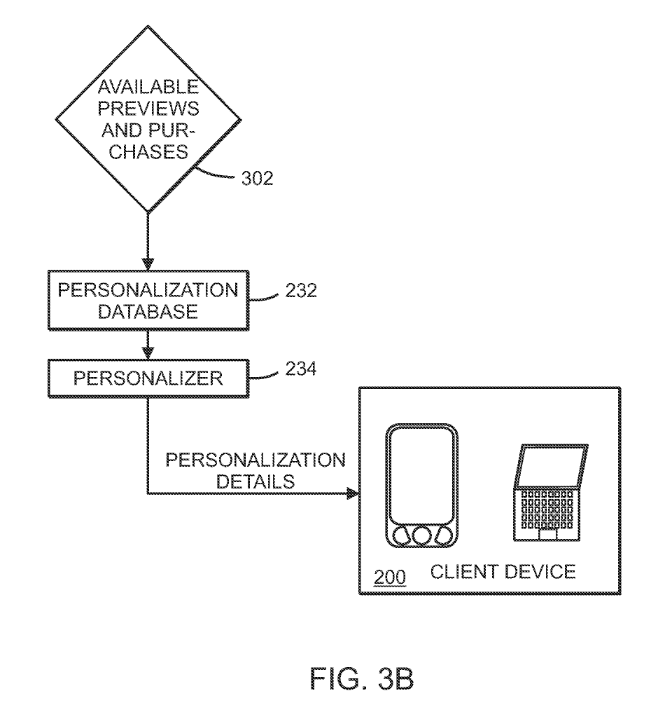

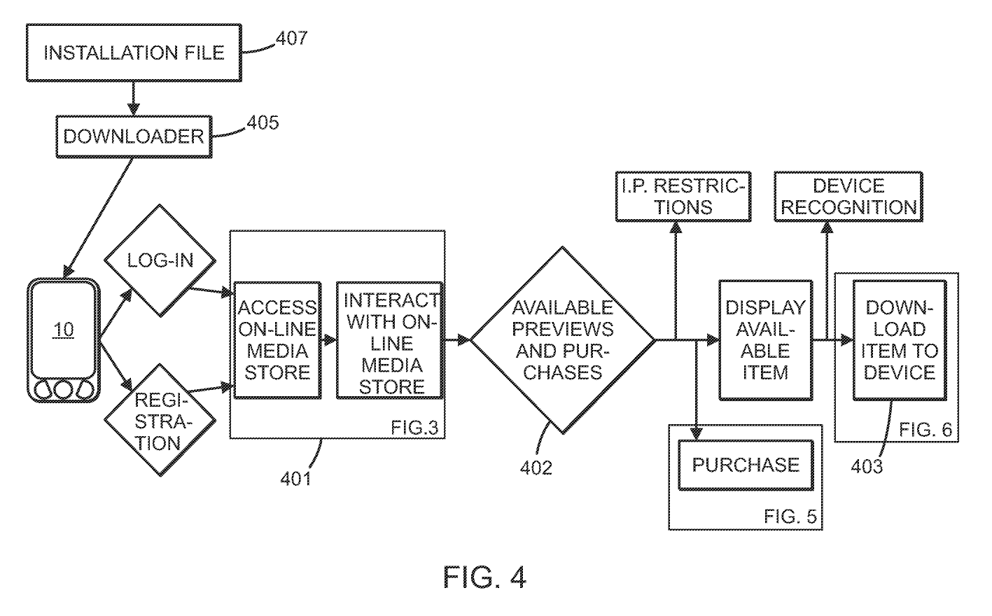

Now is referred to FIG. 3A showing a block schematic for illustrating a method according to an embodiment of the present invention. FIG. 3 shows a method for providing video-ringtone generation in a mobile communication device 200 by means of an external computer according an embodiment of the present invention.

In a first step, video content items are accessed, step 301. This can be provided by accessing an on-line media store and interact with the same. Following log-in or registration, available previews and video content that can be purchased are displayed to the user, step 302. Available video content items are displayed and purchased taking I.P. restrictions into account. Thereafter typically device recognition is performed, i. e. selecting which type of mobile device will receive video content, for instance android, 1-phone, Blackberry etc. Then video item is downloaded (or inputted in some other way) into the mobile communication device 200, followed by associating the particular video content item with a particular caller, step 303; and the mobile communication device 200 is provided with video ring tone information associated with a particular caller. This is described in more detail with reference to FIG. 3B.

In FIG. 3B is shown how available previews and purchases are transferred to a personalization data base 232 controlled by a personalizer 234. The video content associated with the caller is stored in the video ring tone information storage 234 can be contained within a conventional memory of the device 200 by means of suitable software therefore.

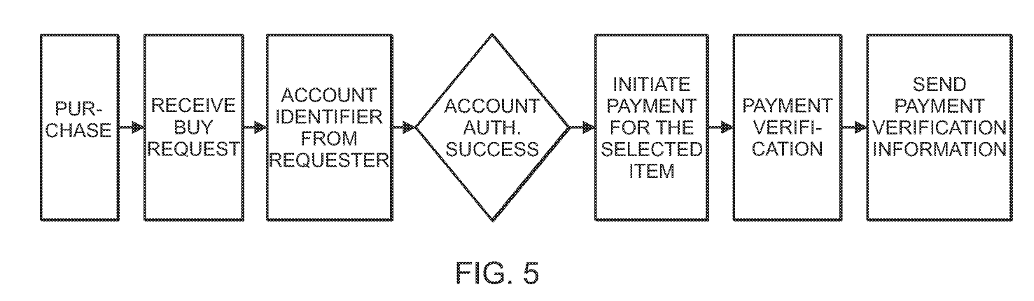

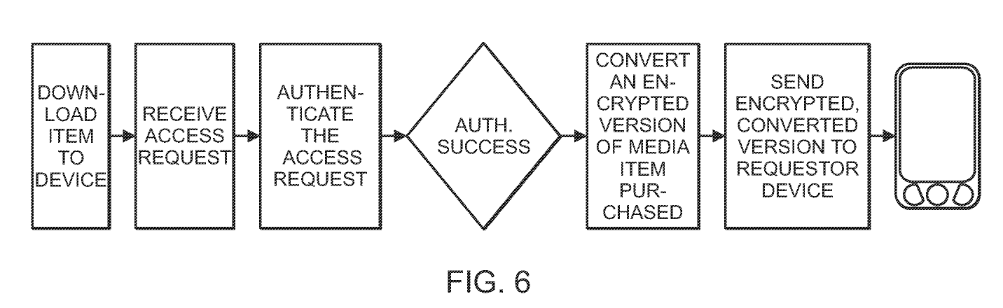

Now is referred to FIG. 4 showing a block schematic for illustrating a method according to an alternative embodiment of the present invention. FIG. 4 shows a method for providing video-ringtone generation in a mobile communication device 200 by means of the device 200 itself according an embodiment of the present invention.

Following log-in or registration, video content items are accessed, step 401. This can be provided by accessing an on-line media store and interact with the same as described in relation to FIG. 3. Available video content items are displayed and purchased taking I.P. restrictions into account, step 402. Thereafter typically device recognition is performed, followed by down loading, step 403. This is provided by means of an installation file 407 and a downloader 405.

Purchase and payment are performed in a conventional way fore-commerce and will therefore not be further described herein since these procedures are well known.

In some embodiments a video file having a sequence of images is associated with a contact. The video file can be any video included compressed or uncompressed formats or even live video stored in RAM. The video file can also be a sequence of still images from a series of individual files that are collectively associated with the contact. Using this method, different video ringtones can be output each time a call is received from the contact.

While throughout the above description the technology has been described as pertaining to video ringtones for use on a mobile communication device, for example a mobile telephone, it is fully contemplated herein to be able to carry out the embodiments described herein on any mobile device capable of receiving incoming communications and having memory and processor means for implementing the inventive method. Accordingly, mobile communication device as it is mentioned above should be considered as no more than an embodiment of the presently described method and device.

The foregoing detailed description is intended to illustrate and provide easier understanding of the invention, and should not be construed as limitations. Alternative embodiments will become apparent to those skilled in the art without departing from the spirit and scope of the present invention.

1. A method for generating a video-ring tone for a mobile communication device, comprising the steps of:
receiving and processing an incoming call, step (100a);
looking up caller information for providing video ring tone information associated with a caller, step (100b);
inputting the video ring tone information associated with a caller into a ring tone module; and
outputting a particular video ring tone in dependence of a particular caller, instead of an audio ring tone, step (100d).

2. A method for providing video-ringtone generation in a mobile communication device (200), comprising the steps of:
providing video content items, step (302);
inputting into a mobile communication device (200) a particular video content item, step (303a);
associating the particular video content item with a particular caller, step (303c); and
providing a data base (234) with video ring tone information associated with a particular caller, step (303c).

3. The method of claim 2, wherein the step of associating is user controlled, step (303c).

4. The method of claim 2, comprising the step(s) of:
by means of another communication device such as a PC initially accessing and interacting with an on-line media store, step (301);
providing available video content items (302a) for preview and/or purchase, step (302); and downloading an item to the mobile communication device, step (303a).

5. The method of claim 2, wherein the method is implemented by a mobile telephone processor comprising a personalizer module () communicating with a video content data base (234) associating the particular video content item with a particular caller.

6. The method of claim 3, wherein the particular video content item is one of a plurality of video sequences associated with a particular caller.

7. A device (200) for generating video ringtones, which comprises a communications interface (210) configured to receive an incoming call from a caller and video media over a mobile telephone network (220), an analyzer (230) for looking up caller information for providing video ring tone information associated with a particular caller and a ring tone module (240) arranged to output a particular video ring tone in dependence of a particular caller, instead of an audio ring tone, wherein communications interface (210), the analyzer (230) and ring tone module are arranged to communicate with each other.
